(19) United States
(12) Patent Application Publication
(10) Pub. No.: US 2025/0292771 A1
(43) Pub. Date: Sep. 18, 2025

(54) SYSTEM AND METHOD FOR A NATURAL LANGUAGE CHAT INTERFACE USING ARTIFICIAL INTELLIGENCE

(71) Applicant: HSI USA Holding, Inc., Frisco, TX (US)

(72) Inventors: Jose Manuel William Arcilla, McKinney, TX (US); Michael Alan Case, Kennewick, WA (US); John William Hambelton, Eugene, OR (US)

(21) Appl. No.: 19/077,783

(22) Filed: Mar. 12, 2025

Related U.S. Application Data
(60) Provisional application No. 63/564,294, filed on Mar. 12, 2024.
(60) Provisional application No. 63/564,784, filed on Mar. 13, 2024.
(60) Provisional application No. 63/565,901, filed on Mar. 15, 2024.
(60) Provisional application No. 63/566,640, filed on Mar. 18, 2024.
(60) Provisional application No. 63/663,991, filed on Jun. 25, 2024.
(60) Provisional application No. 63/663,994, filed on Jun. 25, 2024.
(60) Provisional application No. 63/663,999, filed on Jun. 25, 2024.
(60) Provisional application No. 63/664,004, filed on Jun. 25, 2024.

(51) Int. Cl. G10L 15/22; G06F 21/31; H04L 51/02

(52) U.S. Cl. CPC G10L 15/22; G06F 21/31; H04L 51/02; G10L 2015/223

(57) ABSTRACT

Systems, methods, and computer-readable storage media for a natural language chat interface which uses Artificial Intelligence (AI) to guide users to desired features. A system can receive, at a chat interface, natural language input from a user. Using an AI algorithm on the natural language input, the system can identify a request from the user for a desired action. The system can then identify required data for the desired action and retrieve the required data. The system can then generate an Application Programming Interface (API) call to another computer program based on the desired action, the API call using the retrieved data.

### CROSS-REFERENCE TO RELATED APPLICATIONS

The instant application is a U.S. Non-Provisional Application that claims priority to U.S. Provisional Application No. 63/564,294 filed Mar. 12, 2024, U.S. Provisional Application No. 63/564,784 filed Mar. 13, 2024, U.S. Provisional Application No. 63/565,901 filed Mar. 15, 2024, U.S. Provisional Application No. 63/566,640 filed Mar. 18, 2024, U.S. Provisional Application No. 63/663,994 filed Jun. 25, 2024, U.S. Provisional Application No. 63/663,991 filed Jun. 25, 2024, U.S. Provisional Application No. 63/663,999 filed Jun. 25, 2024 and U.S. Provisional Application No. 63/664,004 filed Jun. 25, 2024, the entire contents of each of which are hereby incorporated by reference in their entireties.

The present application is related to co-pending U.S. application Ser. No. ______, Attorney Docket No. 131637.607931, filed Mar. 12, 2025, U.S. application Ser. No., ______, Attorney Docket No. 131637.607935, filed Mar. 12, 2025, and U.S. application Ser. No. ______, Attorney Docket No. 131637.607978, filed Mar. 12, 2025, the entire contents of each of which are hereby incorporated by reference in their entireties.

### BACKGROUND

### 1. Technical Field

The present disclosure relates to a chat interface, and more specifically to a natural language chat interface which uses Artificial Intelligence (AI) to guide users to desired features.

### 2. Introduction

A data collection platform can require a complex set of records to successfully address the compliance and risk management needs of an organization.

### SUMMARY

Additional features and advantages of the disclosure will be set forth in the description that follows, and in part will be understood from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media which provide a technical solution to the technical problem described. A method for performing the concepts disclosed herein can include: receiving, at a chat interface of a computer system, a natural language input from a user; executing, via at least one processor of the computer system, an Artificial Intelligence (AI) algorithm on the natural language input; identifying, via the at least one processor within the natural language input, a request for a desired action; identifying, via the at least one processor, required data for the desired action; retrieving, via the at least one processor, the required data, resulting in retrieved data; and generating, via the at least one processor, an Application Programming Interface (API) call to another computer program based on the desired action, the API call using the retrieved data.

A system configured to perform the concepts disclosed herein can include: at least one processor; and a non-transitory computer-readable storage medium having instructions stored which, when executed by the at least one processor, cause the at least one processor to perform operations comprising: receiving, at a chat interface, a natural language input from a user; executing an Artificial Intelligence (AI) algorithm on the natural language input; identifying within the natural language input a request for a desired action; identifying required data for the desired action; retrieving the required data, resulting in retrieved data; and generating, via the at least one processor, an Application Programming Interface (API) call to another computer program based on the desired action, the API call using the retrieved data.

A non-transitory computer-readable storage medium configured as disclosed herein can have instructions stored which, when executed by at least one processor, cause the at least one processor to perform operations which include: receiving, at a chat interface, a natural language input from a user; executing an Artificial Intelligence (AI) algorithm on the natural language input; identifying within the natural language input a request for a desired action; identifying required data for the desired action; retrieving the required data, resulting in retrieved data; and generating, via the at least one processor, an Application Programming Interface (API) call to another computer program based on the desired action, the API call using the retrieved data.

### BRIEF DESCRIPTION OF THE DRAWINGS

FIG. 1 illustrates an example system flow diagram;

FIG. 2 illustrates an example method embodiment; and

FIG. 3 illustrates an example computer system.

### DETAILED DESCRIPTION

Various embodiments of the disclosure are described in detail below. While specific implementations are described, this is done for illustration purposes only. Other components and configurations may be used without parting from the spirit and scope of the disclosure.

A data collection platform requires a complex set of records to successfully address the compliance and risk management needs of an organization. For example, for an Environmental, Health, Safety, and Quality (EHSQ) record program, the records can include incidents, audits, contractor management, checklists, inspections, observations, asset management, and many others. Each record type contains their own set of data unique to their purpose.

For some platforms, the data being received as records is a heavy flow of continuous manual and automated data entry. The entry effort has many issues that prevent an efficient and effective program. For example, those entering the information may represent diverse roles across an organization with various levels of technical expertise, and some of those entering the information may be proficient at entering the data, and others less so. Many entries, especially initial entries, may be completed by staff with low technical experience and high turnover. In addition, manual entry is slow, often inconvenient, inaccurate, and often requires many steps just to get to the correct entry interfaces. The use of mobile devices for data entry multiplies these problems by presenting alternative interfaces that require more training, while the touch-based input interfaces of mobile devices slow the entry effort. In addition to the data entry issues noted, there can be administrative issues. For example, a platform administrator may have access to a much larger set of features, which may be used infrequently. Maintaining knowledge of these infrequently used features is difficult, and may result in additional problems.

Systems configured as disclosed herein implement a single AI chat interface with access to perform tasks on behalf of the user will solve many of these problems. The single AI chat interface can be the initial point of entry for all actions performed by users, including low-level end users and/or administrators (or those of higher level). The users can state their purpose to the chat interface using a natural language interface, and can be quickly guided through the required steps to complete a data recording task. Unlike chat interfaces which use a predetermined set of functions/commands available through which the chat system identifies the content and context of a user's message, systems configured as disclosed herein include a dynamic library of functions available to it, where those functions vary (i.e., are added, removed, made available, not made available, etc.) based on the user's permissions for that session. Once the dynamic library of functions for a given user has been identified, the dynamic library is injected as an API (Application Programming Interface) schema providing definition of the structure and data types for the API, and merges the resulting access and permissions with the user's prompt. Because the AI chat interface has permission to act on behalf of the user, the AI can use the answers provided by the user to not only guide the user, but to perform the action itself. For example, the chatbot operating in the context of the authenticated user's login session has access to all the underlying micro-services and endpoints the user has access to and is able (with the user's permission) to perform actions on the user's behalf. Thus, chatbots configured as disclosed herein are designed to act on behalf of the user while adhering to that user's complex data security and role access permissions. For all users, especially low-level roles, such AI chat interfaces eliminate the need to maintain platform knowledge, significantly reducing barriers to entry for high turnover and low technical expertise users. In addition, the system is highly configurable such that there is significant variation in the data collected and the objects that data represents between user implementations. The system can then use the distinct data collected and the configuration information in answering questions via the chat interface and the underlying model.

The AI chat interface can, for example, use a text-based interface, where users type in information into a chat window and the system generates text responses while recording data to a record. On mobile devices (which are the preferred tool for implementing the AI chat interface) additional input mechanisms can include built-in cameras, video recorders, and microphones, making media-based entry easier. For example, using the microphone, the user can provide spoken input to the system, which is converted to text and subsequently interpreted by the AI, with a data record being completed based on the AI interpretation.

When the AI identifies, based on the user's input, follow-up questions, a predefined protocol, or additional data requirements, the system can communicate such identifications through the system output modules. For example, if the system is a smartphone or mobile computing device with a display, and the display is being used to input the data with the help of a keyboard or keypad, the system may request additional information, provide the next steps, or otherwise communicate with the user through the screen. Likewise, if the user is providing data to the system using a microphone, the system may request additional information, provide the next steps, or otherwise communicate with the user using a speaker. In some configurations, the system may use one or more combinations of input/output mechanisms, such as a combination of screen, keypad, microphone, and speaker.

Platform administrators can also use this interface as an alternative method to traditional administrative tasks. For example, if an administrator needs to add a user to the system, but has forgotten how to perform this task, the administrator can query the AI, who will gather the needed user information and add the user on the administrator's behalf. If the administrator wants to view the actions of the AI, the chat interface can guide them to the record created for the user. For example, administrators can perform actions like creating new users in the system; adding, updating, approving, and removing records within the system; and/or accessing confidential data.

Because the AI, as part of its training model, has access to a variety of services associated with a record keeping system, the end result is a system where a user can input to the AI chat interface “I need to report an incident,” and the AI is trained to know what an incident is, what information is required to create an incident record, prompt the user for that information, and then submit that incident record on their behalf. The schema of functions that the chatbot has access to can include the full library of functions in the application, but in the context of any user session it can only act on the functions for which the end-user's authorization token is allowed.

To train the AI, the training data can include a list of actions and a list of the requirements of each of those actions. The system then includes the ability for the AI to interface with the user. When in use (i.e., once the user inputs information into the chat interface) the model works using the following data sets: 1) the user's prompt, and 2) the system's configuration context, including modules, modular relationships, field definitions, the system's API schema, and/or the user's API schema as limited by the user's authorization token. When the user provides inputs which the AI recognizes as an action, the AI can identify that action, recognize the requirements associated with that action, verify the user's authorization level, and act on behalf of the user.

In addition, the chat interface system disclosed herein does not require a screen, keyboard, mouse, and/or other touch interface to operate. Instead, the chat interface system disclosed herein can operate using voice/audible input, where a microphone captures the user's voice, performs natural language processing on the recorded voice to identify the content and/or context of the audible inputs, and processes the information accordingly. In some configurations, the voice processing can further be used to verify/authenticate the user. For example, the audio processing can identifying specific frequencies, durations, etc. associated with how the user speaks predetermined words, thereby allowing for the system to identify the user based on their voice. In other configurations, the user may need to provide a specific code (which can be provided audibly or using a keypad, etc.) for authorization. In still other configurations a keycard or other ID may be used (e.g., an ID with built in Radio Frequency Identification (RFID)).

In some configurations, and based on the specific details of the chat, the system can create data that triggers automations, including those that interact with other systems via application programming interface (API) calls. Those external systems could include activating sensors, alarms, locks, and other Internet of Things (IoT) devices.

The chat interface is an improvement to the traditional Graphical User Interfaces (GUIs) available. Instead of a user needing to remember how to navigate through the system using graphical menus, links, and buttons, the user can simply describe what actions they intend to take, and the chatbot, through conversation, will either take action directly, or where needed, ask clarifying questions to gather sufficient information to act.

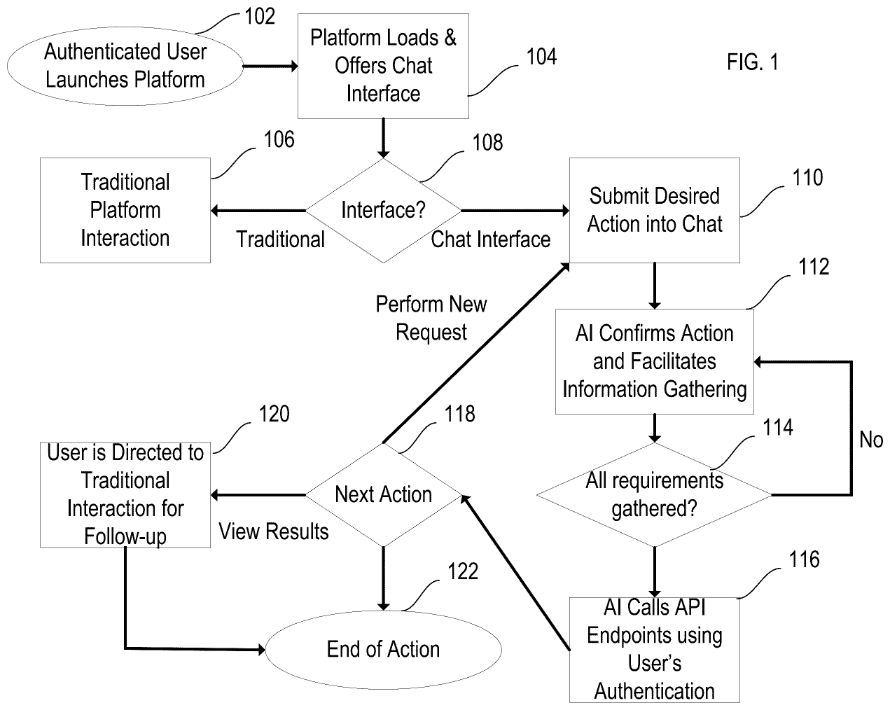

FIG. 1 illustrates an example system flow diagram. As illustrated, an authenticated user launches the platform 102. The launching of the platform can, for example occur through a mobile device, a web browser, or other computing device. This allows the system to identify the identity of the user and their level of authorization. The platform can then load and offer the user a chat interface 104. In some configurations, the user can be given an option for how they would like to interface 108 with the system. For some users, they would prefer a traditional platform interaction 106 (e.g., interacting with a non-AI enabled chatbot, waiting for a human being to connect to the chat window, identifying a specific form to fill out and filling it out manually, etc.). Alternatively, the user can use the system disclosed herein, with an AI enabled chat interface.

When the user selects the AI enabled chat interface disclosed herein, the user can submit the desired action into the chat 110. For example, the user can input “I need to report an incident.” The AI then confirms the action and facilitates information gathering 112. This can, for example, mean that the AI searches through the actions to which it has access to and determines if there is an action or implementation which addresses the desired action, and does this person have access to the action/implementations identified by the AI. If the user is authorized, the AI begins gathering facts and data to fulfill the requirements of the desired action. This information gathering can continue until all requirements are gathered 114. At that point, the AI can call one or more Application Programming Interface (API) endpoint using the user's authentication 116. In other words, the system can send and receive information from other programs or databases according to the desired action. In the reporting of an incident example, the API may be used to send the completed record to an authority responsible for remediation and other corrective actions associated with the incident. Upon calling the API using the user's authentication 116, the system can move to a next action 118, at which point it is possible for the user to enter an additional desired action into the chat 110. Alternatively, the user can be directed to a traditional interaction for a follow-up 120, or the interaction can end 122.

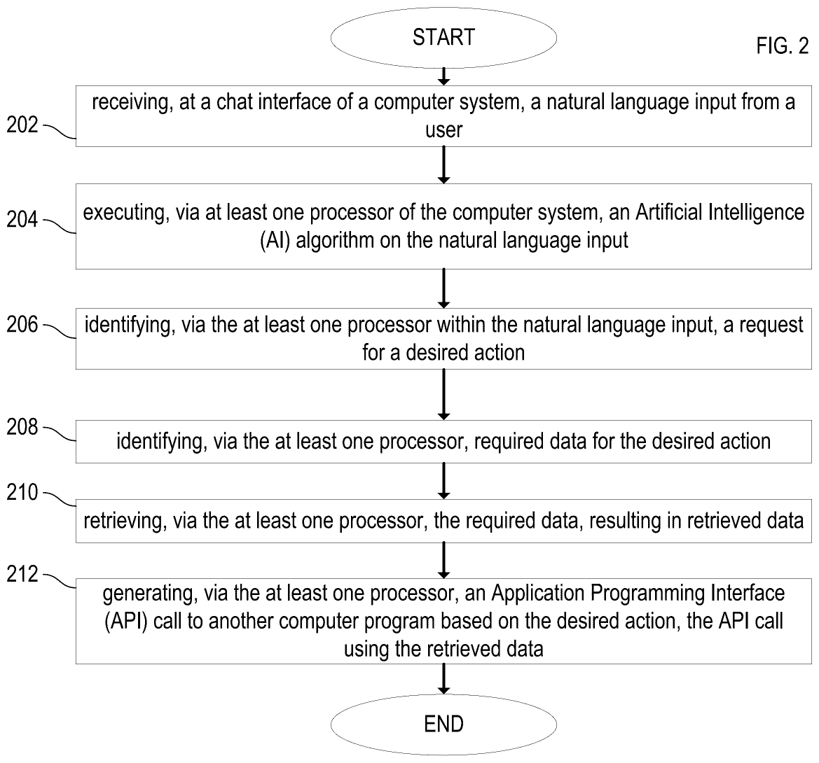

FIG. 2 illustrates an example method embodiment. As illustrated, the method can include: receiving, at a chat interface of a computer system, a natural language input from a user (202) and executing, via at least one processor of the computer system, an Artificial Intelligence (AI) algorithm on the natural language input (204). The method continues by identifying, via the at least one processor within the natural language input, a request for a desired action (206) and identifying, via the at least one processor, required data for the desired action (208). The method then includes retrieving, via the at least one processor, the required data, resulting in retrieved data (210) and generating, via the at least one processor, an Application Programming Interface (API) call to another computer program based on the desired action, the API call using the retrieved data (212).

In some configurations, the natural language input can be received in a text format.

In some configurations, the natural language input can be received in a speech format.

In some configurations, the desired action can be a reporting of an incident. In such configurations, the incident can be one or more of an Environmental incident, a Health incident, a Safety incident, and a Quality incident.

In some configurations, the illustrated method can further include, prior to the identifying of the required data: receiving, at the computer system, an authorization level of the user; and verifying, via the at least one processor, that the desired action is authorized by the authorization level of the user.

In some configurations, the retrieving of the required data can include: iteratively generating, via the at least one processor, at least one request to the user for additional information; and receiving, at the computer system from the user, answers to the at least one request.

In some configurations, the retrieving of the required data can include: transmitting a query for a portion of the required data to a database; and receiving the portion of the required data from the database in response to the query, until a threshold amount of the required data is retrieved.

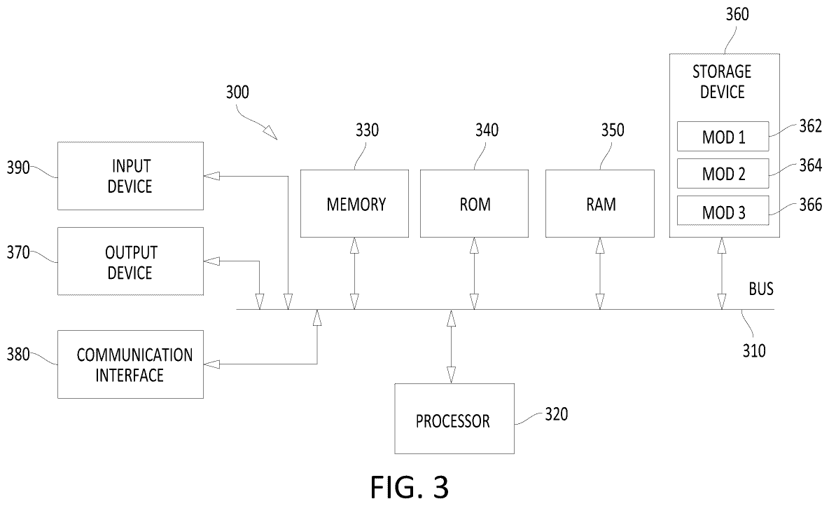

With reference to FIG. 3, an exemplary system includes a computing device 300 (such as a general-purpose computing device), including a processing unit (CPU or processor) 320 and a system bus 310 that couples various system components including the system memory 330 such as read-only memory (ROM) 340 and random access memory (RAM) 350 to the processor 320. The computing device 300 can include a cache of high-speed memory connected directly with, in close proximity to, or integrated as part of the processor 320. The computing device 300 copies data from the system memory 330 and/or the storage device 360 to the cache for quick access by the processor 320. In this way, the cache provides a performance boost that avoids processor 320 delays while waiting for data. These and other modules can control or be configured to control the processor 320 to perform various actions. Other system memory 330 may be available for use as well. The system memory 330 can include multiple different types of memory with different performance characteristics. It can be appreciated that the disclosure may operate on a computing device 300 with more than one processor 320 or on a group or cluster of computing devices networked together to provide greater processing capability. The processor 320 can include any general-purpose processor and a hardware module or software module, such as module 1 362, module 2 364, and module 3 366 stored in storage device 360, configured to control the processor 320 as well as a special-purpose processor where software instructions are incorporated into the actual processor design. The processor 320 may essentially be a completely self-contained computing system, containing multiple cores or processors, a bus, memory controller, cache, etc. A multi-core processor may be symmetric or asymmetric.

The system bus 310 may be any of several types of bus structures including a memory bus or memory controller, a peripheral bus, and a local bus using any of a variety of bus architectures. A basic input/output (BIOS) stored in memory ROM 340 or the like, may provide the basic routine that helps to transfer information between elements within the computing device 300, such as during start-up. The computing device 300 further includes storage devices 360 such as a hard disk drive, a magnetic disk drive, an optical disk drive, tape drive or the like. The storage device 360 can include software modules 362, 364, 366 for controlling the processor 320. Other hardware or software modules are contemplated. The storage device 360 is connected to the system bus 310 by a drive interface. The drives and the associated computer-readable storage media provide nonvolatile storage of computer-readable instructions, data structures, program modules and other data for the computing device 300. In one aspect, a hardware module that performs a particular function includes the software component stored in a tangible computer-readable storage medium in connection with the necessary hardware components, such as the processor 320, system bus 310, output device 370 (such as a display or speaker), and so forth, to carry out the function. In another aspect, the system can use a processor and computer-readable storage medium to store instructions which, when executed by a processor (e.g., one or more processors), cause the processor to perform a method or other specific actions. The basic components and appropriate variations are contemplated depending on the type of device, such as whether the computing device 300 is a small, handheld computing device, a desktop computer, or a computer server.

Although the exemplary embodiment described herein employs the storage device 360 (such as a hard disk), other types of computer-readable media which can store data that are accessible by a computer, such as magnetic cassettes, flash memory cards, digital versatile disks, cartridges, random access memories (RAMs) 350, and read-only memory (ROM) 340, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 300, an input device 390 represents any number of input mechanisms, such as a microphone for speech, a touch-sensitive screen for gesture or graphical input, keyboard, mouse, motion input, speech and so forth. An output device 370 can also be one or more of a number of output mechanisms known to those of skill in the art. In some instances, multimodal systems enable a user to provide multiple types of input to communicate with the computing device 300. The communications interface 380 generally governs and manages the user input and system output. There is no restriction on operating on any particular hardware arrangement and therefore the basic features here may easily be substituted for improved hardware or firmware arrangements as they are developed.

The technology discussed herein refers to computer-based systems and actions taken by, and information sent to and from, computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

Use of language such as “at least one of X, Y, and Z,” “at least one of X, Y, or Z,” “at least one or more of X, Y, and Z,” “at least one or more of X, Y, or Z,” “at least one or more of X, Y, and/or Z,” or “at least one of X, Y, and/or Z,” are intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure. For example, unless otherwise explicitly indicated, the steps of a process or method may be performed in an order other than the example embodiments discussed above. Likewise, unless otherwise indicated, various components may be omitted, substituted, or arranged in a configuration other than the example embodiments discussed above.

Further aspects of the present disclosure are provided by the subject matter of the following clauses.

A method comprising: receiving, at a chat interface of a computer system, a natural language input from a user; executing, via at least one processor of the computer system, an Artificial Intelligence (AI) algorithm on the natural language input; identifying, via the at least one processor within the natural language input, a request for a desired action; identifying, via the at least one processor, required data for the desired action; retrieving, via the at least one processor, the required data, resulting in retrieved data; and generating, via the at least one processor, an Application Programming Interface (API) call to another computer program based on the desired action, the API call using the retrieved data.

The method of any preceding clause, wherein the natural language input is received in a text format.

The method of any preceding clause, wherein the natural language input is received in a speech format.

The method of any preceding clause, wherein the desired action is a reporting of an incident.

The method of any preceding clause, wherein the incident is one of an Environmental incident, a Health incident, a Safety incident, and a Quality incident.

The method of any preceding clause, further comprising, prior to the identifying of the required data: receiving, at the computer system, an authorization level of the user; and verifying, via the at least one processor, that the desired action is authorized by the authorization level of the user.

The method of any preceding clause, wherein the retrieving of the required data comprises: iteratively generating, via the at least one processor, at least one request to the user for additional information; and receiving, at the computer system from the user, answers to the at least one request.

The method of any preceding clause, wherein the retrieving of the required data comprises: transmitting a query for a portion of the required data to a database; and receiving the portion of the required data from the database in response to the query, until a threshold amount of the required data is retrieved.

A system comprising: at least one processor; and a non-transitory computer-readable storage medium having instructions stored which, when executed by the at least one processor, cause the at least one processor to perform operations comprising: receiving, at a chat interface, a natural language input from a user; executing an Artificial Intelligence (AI) algorithm on the natural language input; identifying within the natural language input a request for a desired action; identifying required data for the desired action; retrieving the required data, resulting in retrieved data; and generating, via the at least one processor, an Application Programming Interface (API) call to another computer program based on the desired action, the API call using the retrieved data.

The system of any preceding clause, wherein the natural language input is received in a text format.

The system of any preceding clause, wherein the natural language input is received in a speech format.

The system of any preceding clause, wherein the desired action is a reporting of an incident.

The system of any preceding clause, wherein the incident is one of an Environmental incident, a Health incident, a Safety incident, and a Quality incident.

The system of any preceding clause, the non-transitory computer-readable storage medium having additional instructions stored which, when executed by the at least one processor, cause the at least one processor to perform operations comprising, prior to the identifying of the required data: receiving authorization level of the user; and verifying that the desired action is authorized by the authorization level of the user.

The system of any preceding clause, wherein the retrieving of the required data comprises: iteratively generating, via the at least one processor, at least one request to the user for additional information; and receiving, from the user, answers to the at least one request.

The system of any preceding clause, wherein the retrieving of the required data comprises: transmitting a query for a portion of the required data to a database; and receiving the portion of the required data from the database in response to the query, until a threshold amount of the required data is retrieved.

A non-transitory computer-readable storage medium having instructions stored which, when executed by at least one processor, cause the at least one processor to perform operations comprising: receiving, at a chat interface, a natural language input from a user; executing an Artificial Intelligence (AI) algorithm on the natural language input; identifying within the natural language input a request for a desired action; identifying required data for the desired action; retrieving the required data, resulting in retrieved data; and generating, via the at least one processor, an Application Programming Interface (API) call to another computer program based on the desired action, the API call using the retrieved data.

The non-transitory computer-readable storage medium of any preceding clause, wherein the natural language input is received in a text format.

The non-transitory computer-readable storage medium of any preceding clause, wherein the natural language input is received in a speech format.

The non-transitory computer-readable storage medium of any preceding clause, wherein the desired action is a reporting of an incident.

We claim:

1. A method comprising:
receiving, at a chat interface of a computer system, a natural language input from a user;
executing, via at least one processor of the computer system, an Artificial Intelligence (AI) algorithm on the natural language input;
identifying, via the at least one processor within the natural language input, a request for a desired action;
identifying, via the at least one processor, required data for the desired action;
retrieving, via the at least one processor, the required data, resulting in retrieved data; and
generating, via the at least one processor, an Application Programming Interface (API) call to another computer program based on the desired action, the API call using the retrieved data.

2. The method of claim 1, wherein the natural language input is received in a text format.

3. The method of claim 1, wherein the natural language input is received in a speech format.

4. The method of claim 1, wherein the desired action is a reporting of an incident.

5. The method of claim 4, wherein the incident is one of an Environmental incident, a Health incident, a Safety incident, and a Quality incident.

6. The method of claim 1, further comprising, prior to the identifying of the required data:
receiving, at the computer system, an authorization level of the user; and
verifying, via the at least one processor, that the desired action is authorized by the authorization level of the user.

7. The method of claim 1, wherein the retrieving of the required data comprises:
iteratively generating, via the at least one processor, at least one request to the user for additional information; and
receiving, at the computer system from the user, answers to the at least one request.

8. The method of claim 1, wherein the retrieving of the required data comprises:
transmitting a query for a portion of the required data to a database; and
receiving the portion of the required data from the database in response to the query,
until a threshold amount of the required data is retrieved.

9. A system comprising:
at least one processor; and
a non-transitory computer-readable storage medium having instructions stored which, when executed by the at least one processor, cause the at least one processor to perform operations comprising:
receiving, at a chat interface, a natural language input from a user;
executing an Artificial Intelligence (AI) algorithm on the natural language input;
identifying within the natural language input a request for a desired action;
identifying required data for the desired action;
retrieving the required data, resulting in retrieved data; and
generating, via the at least one processor, an Application Programming Interface (API) call to another computer program based on the desired action, the API call using the retrieved data.

10. The system of claim 9, wherein the natural language input is received in a text format.

11. The system of claim 9, wherein the natural language input is received in a speech format.

12. The system of claim 9, wherein the desired action is a reporting of an incident.

13. The system of claim 12, wherein the incident is one of an Environmental incident, a Health incident, a Safety incident, and a Quality incident.

14. The system of claim 9, the non-transitory computer-readable storage medium having additional instructions stored which, when executed by the at least one processor, cause the at least one processor to perform operations comprising, prior to the identifying of the required data:
receiving authorization level of the user; and
verifying that the desired action is authorized by the authorization level of the user.

15. The system of claim 9, wherein the retrieving of the required data comprises:
iteratively generating, via the at least one processor, at least one request to the user for additional information; and
receiving, from the user, answers to the at least one request.

16. The system of claim 9, wherein the retrieving of the required data comprises:
transmitting a query for a portion of the required data to a database; and
receiving the portion of the required data from the database in response to the query,
until a threshold amount of the required data is retrieved.

17. A non-transitory computer-readable storage medium having instructions stored which, when executed by at least one processor, cause the at least one processor to perform operations comprising:
receiving, at a chat interface, a natural language input from a user;
executing an Artificial Intelligence (AI) algorithm on the natural language input;
identifying within the natural language input a request for a desired action;
identifying required data for the desired action;
retrieving the required data, resulting in retrieved data; and
generating, via the at least one processor, an Application Programming Interface (API) call to another computer program based on the desired action, the API call using the retrieved data.

18. The non-transitory computer-readable storage medium of claim 17, wherein the natural language input is received in a text format.

19. The non-transitory computer-readable storage medium of claim 17, wherein the natural language input is received in a speech format.

20. The non-transitory computer-readable storage medium of claim 17, wherein the desired action is a reporting of an incident.
